(19) United States
(12) Patent Application Publication
(10) Pub. No.: US 2024/0024991 A1
(43) Pub. Date: Jan. 25, 2024

(54) Solder Material and Solder Material Production Method

(71) Applicant: KOKI COMPANY LIMITED, Adachi-ku, Tokyo (JP)

(72) Inventors: Akane TANAKA, Adachi-ku, Tokyo (JP); Takeshi YAHAGI, Adachi-ku, Tokyo (JP)

(73) Assignee: KOKI COMPANY LIMITED, Adachi-ku, Tokyo (JP)

(21) Appl. No.: 18/039,090

(22) PCT Filed: Dec. 22, 2021
(86) PCT No.: PCT/JP2021/047677

§ 371 Date: May 26, 2023

(30) Foreign Application Priority Data
Dec. 23, 2020 (JP) 2020-214338

(51) Int. Cl. B23K 35/36; B23K 35/02

(52) U.S. Cl. CPC B23K 35/3613; B23K 35/025

(57) ABSTRACT

A method of producing a solder material is provided. The method includes mixing a flux containing a solvent, a rosin-based resin, and an activator, with aggregated cellulose. The aggregated cellulose includes massive cellulose in which fibrous cellulose having a length of from 1 μm or more to less than 1 mm, and fibrous cellulose having a length of from 1 nm or more to less than 1 μm. The resulting mixture is mixed with a solder alloy to produce a solder material.

### TECHNICAL FIELD

The present invention relates to a solder material and a method of producing the solder material.

### BACKGROUND ART

A solder used for bonding electronic components and the like is made of a solder material containing a solder alloy and a flux. As the solder material, a solder material in which a solder alloy, a flux, and the like are mixed in a paste form, and the like are known. The solder material is disposed, for example, at a component joint portion of a printed wiring board by a coating means such as printing, a joint component such as an electronic component is disposed on the solder material, the solder material is melted by heating (reflow), and the joint portion and the joint portion are solder-joined. During this reflow, a volatile component in the flux is volatilized to generate gas, and the gas may scatter the flux or solder balls (hereinafter, this scattering is also simply referred to as scattering). As a technique for suppressing such scattering, for example, Patent Document 1 describes using an antifoaming agent that is a specific solubility parameter as a flux component. However, solder materials containing these conventional fluxes have a problem that scattering cannot be sufficiently suppressed.

### DOCUMENT FOR PRIOR ART

### Patent Document

Patent Document 1: JP 2015-131336 A

### SUMMARY OF INVENTION

### Problem to be Solved by the Invention

The present invention has been made in view of the above-described problems of the prior art, and an object of the present invention is to provide a solder material capable of sufficiently suppressing occurrence of scattering during heating, and a method of producing the solder material.

### Means for Solving the Problems

A solder material of the present invention contains massive cellulose in which fibrous cellulose having a length of 1 μm or more and less than 1 mm and fibrous cellulose having a length of 1 nm or more and less than 1 μm are mixed.

The present invention may contain 50 ppm or more and 20,000 ppm or less of the massive cellulose.

The present invention may further include a flux containing a solvent, a rosin-based resin, and an activator.

In the present invention related to a method of producing a solder material, a flux containing a solvent, a rosin-based resin, and an activator is mixed with massive cellulose in which fibrous cellulose having a length of 1 μm or more and less than 1 mm and fibrous cellulose having a length of 1 nm or more and less than 1 μm are mixed to obtain a mixture, and the mixture is mixed with a solder alloy to produce a solder material.

### Effects of Invention

According to the present invention, it is possible to provide a solder material capable of sufficiently suppressing occurrence of scattering during heating, and a method of producing the solder material.

### BRIEF DESCRIPTION OF DRAWINGS

FIG. 1 is an electron micrograph of cellulose used in Comparative Example.

FIG. 2 is an electron micrograph of the cellulose used in Comparative Example.

FIG. 3 is an electron micrograph of the cellulose used in Comparative Example.

FIG. 4 is an electron micrograph of the cellulose used in Comparative Example.

FIG. 5 is an electron micrograph of the cellulose used in Comparative Example.

FIG. 6 is an electron micrograph of the cellulose used in Comparative Example.

FIG. 7 is an electron micrograph of the cellulose used in Comparative Example.

FIG. 8 is an electron micrograph of the cellulose used in Comparative Example.

FIG. 9 is an electron micrograph of the cellulose used in Comparative Example.

FIG. 10 is an electron micrograph of the cellulose used in Example.

FIG. 11 is an electron micrograph of the cellulose used in Example.

FIG. 12 is an electron micrograph of the cellulose used in Example.

FIG. 13 is an electron micrograph of the cellulose used in Example.

FIG. 14 is an electron micrograph of the cellulose used in Example.

### DESCRIPTION OF EMBODIMENTS

Hereinafter, a solder material and a method of producing a solder material (hereinafter, also simply referred to as a production method) according to the present invention will be described.

First, the solder material of the present embodiment will be described.

The solder material of the present invention contains massive cellulose in which fibrous cellulose having a length of 1 μm or more and less than 1 mm and fibrous cellulose having a length of 1 nm or more and less than 1 μm are mixed.

The massive cellulose contained in the solder material of the present embodiment is fibrous cellulose made of cellulose such as methyl cellulose, ethyl cellulose, or hydroxyethyl cellulose, and is massive cellulose in which fibrous cellulose having a length of 1 μm or more and less than 1 mm and fibrous cellulose having a length of 1 nm or more and less than 1 μm are mixed.

The massive cellulose of the solder material of the present embodiment is a powder matter made of massive cellulose in which fine fibers having different lengths are entangled.

In the present embodiment, the length of the fibrous cellulose is the length of the fiber measured in an electron micrograph taken by a method shown in Example described later.

The massive cellulose is not particularly limited as long as it is massive cellulose in which fibrous celluloses having different lengths are mixed as described above, and examples of such massive cellulose include cellulose fibers called “microfibrillated cellulose (MFC)”. The microfibrillated cellulose is also called “cellulose microfiber”, and is cellulose in which various cellulose raw materials are mechanically and/or chemically treated to increase the specific surface area and adjust the diameter and length of fibers.

The raw material of the cellulose microfiber is any cellulose material, and is not particularly limited, and examples thereof include natural materials such as wood and chemically synthesized cellulose fibers.

The massive cellulose contained in the solder material of the present embodiment may be obtained from a commercially available product. Examples thereof include Exilva (manufactured by Borregaard AS) and BiNFi-s (manufactured by Sugino Machine Limited).

The solder material of the present embodiment may contain 50 ppm or more and 20,000 ppm or less, 100 ppm or more and 15,000 ppm or less, 200 ppm or more and 12,500 ppm or less, or 300 ppm or more and 10,000 ppm or less of the massive cellulose.

When the concentration of the massive cellulose is within the above range, meltability during solder bonding can be properly adjusted while scattering of the flux is suppressed.

In the present embodiment, the concentration of the massive cellulose means an effective cellulose equivalent (ppm). The effective cellulose equivalent is a value measured by a measurement method of Examples described later.

As a method of determining the effective cellulose equivalent from the solder material, the effective cellulose equivalent (ppm) is measured based on the following formula.

Effective cellulose equivalent (ppm)=weight of separated and extracted cellulose (g)/(weight of solder material used in extraction operation (g)×1 million.

The solder material of the present embodiment may contain any other component generally contained in the solder material, and for example, may further contain a flux containing a solvent, a rosin-based resin, and an activator.

The solvent is not particularly limited as long as it is a known component used as a solvent component of the flux. Examples thereof include glycol ethers such as diethylene glycol monohexyl ether, diethylene glycol dibutyl ether, diethylene glycol mono-2-ethylhexyl ether, diethylene glycol monobutyl ether, tripropylene glycol monobutyl ether, polypropylene glycol monobutyl ether, triethylene glycol monobutyl ether, and polyethylene glycol dimethyl ether; aliphatic compounds such as n-hexane, isohexane, n-heptane, octane, and decane; esters such as isopropyl acetate, methyl propionate, ethyl propionate, tris(2-ethylhexyl) trimellitate, tributyl acetylcitrate, and diethylene glycol dibenzoate; ketones such as methyl ethyl ketone, methyl-n-propyl ketone, and diethyl ketone; alcohols such as ethanol, n-propanol, isopropanol, isobutanol, octanediol, and 3-methyl-1,5-pentanediol; and carboxylic acids such as hexanoic acid, heptanoic acid, octanoic acid, 2-ethylhexanoic acid, nonanoic acid, and decanoic acid.

The solvent can be used alone or in combination of two or more kinds thereof.

The content of the solvent component in the flux is not particularly limited, and is, for example, 20% by mass or more and 70% by mass or less, preferably 30% by mass or more and 60% by mass or less.

Examples of the rosin-based resin include rosin and a resin that is a derivative of rosin, and the rosin-based resin is not particularly limited as long as it is a known rosin-based resin used as a resin component of a flux. Specific examples thereof include rosin derivative resins such as rosin, hydrogenated rosin, polymerized rosin, disproportionated rosin, maleic acid-modified rosin, maleic acid-modified hydrogenated rosin, acrylic acid-modified rosin, acrylic acid-modified hydrogenated rosin, and pentaerythritol ester.

The rosin-based resin can be used alone or in combination of two or more kinds thereof.

The content of the rosin-based resin in the flux used in the present embodiment is not particularly limited, and is, for example, 20% by mass or more and 95% by mass or less, preferably 25% by mass or more and 90% by mass or less, more preferably 30% by mass or more and 80% by mass or less. When the content of the rosin-based resin is within the above range, it is preferable from the viewpoint of solderability.

The activator is not particularly limited as long as it is a known component used as an activator component or the like of the flux. For example, a halogen-based activator such as an organic acid, an amine halogen salt, or a halogen compound, an isocyanuric acid derivative activator, an imidazole-based activator, or the like can be used.

Examples of the organic acid include adipic acid, malonic acid, maleic acid, glutaric acid, succinic acid, methylsuccinic acid, azelaic acid, sebacic acid, stearic acid, benzoic acid, dodecanedioic acid, and cyanuric acid.

Examples of the halogen-based activator include 2,3-dibromo-2-butene-1,4-diol, diiodooctane, and diiodobiphenyl.

Examples of the isocyanuric acid derivative activator include tris(3-carboxypropyl) isocyanurate, tris(2-carboxyethyl) isocyanurate, and bis(2-carboxyethyl) isocyanurate.

Examples of the imidazole-based activator include imidazole, 2-methylimidazole, 2-ethylimidazole, 2-vinylimidazole, 2-propylimidazole, 2-isopropylimidazole, 2-phenylimidazole, 2-undecylimidazole, 2-heptadecylimidazole, 1,2 dimethylimidazole, 2-ethyl-4-methylimidazole, and 2-phenyl-4-methylimidazole.

The activator can be used alone or in combination of two or more kinds thereof.

The total amount of the activator in the flux is not particularly limited, and is, for example, 0.1% by mass or more and 20% by mass or less, or 1% by mass or more and 10% by mass or less.

When the content of the activator is within the above range, it is preferable from the viewpoint of maintaining soldering while suppressing the occurrence of scattering.

The flux used in the present embodiment may further contain a thixotropic component.

The thixotropic component is not particularly limited as long as it is a known component used as the thixotropic component of the flux. Examples thereof include fatty acid amides, hydrogenated castor oil, oxyfatty acids, and waxes.

The thixotropic component can be used alone or in combination of two or more kinds thereof.

The content of the thixotropic component in the flux is not particularly limited, and is, for example, 3.0% by mass or more and 20% by mass or less, preferably 4.5% by mass or more and 10% by mass or less.

The flux in the present embodiment may further contain other additives. For example, cellulose other than the massive cellulose may be contained as a thickener.

Each of these components can be blended in the flux as necessary, and any component may or may not be contained.

The flux in the present embodiment can be used as a flux for a solder material such as a solder paste.

The solder material of the present embodiment contains each of the fluxes and a solder alloy.

The solder alloy may be a lead-free alloy.

The solder alloy is not particularly limited and may be either a lead-free (unleaded) solder alloy or a leaded solder alloy, and from the viewpoint of the impact on the environmental, the lead-free solder alloy is preferable.

Specific examples of the lead-free solder alloy include alloy containing tin, silver, copper, zinc, bismuth, antimony, or indium, and more specific examples include alloy such as Sn/Ag, Sn/Ag/Cu, Sn/Cu, Sn/Ag/Bi, Sn/Bi, Sn/Ag/Cu/Bi, Sn/Sb, Sn/Zn/Bi, Sn/Zn, Sn/Zn/Al, Sn/Ag/Bi/In, Sn/Ag/Cu/Bi/In/Sb, and In/Sn. Particularly, Sn/Ag/Cu is preferable.

The content of the solder alloy in the solder material is not particularly limited, and is, for example, 80% by mass or more and 95% by mass or less, preferably 85% by mass or more and 90% by mass or less.

When the solder material of the present embodiment is a solder paste obtained by mixing a solder alloy and the flux of the present embodiment, for example, it is preferable that the solder alloy is mixed at 80% by mass or more and 95% by mass or less and the flux is mixed at 5% by mass or more and 20% by mass or less.

The conditions in the case of using the solder material of the present embodiment can be appropriately set according to an object to be solder-joined and the like, and are not particularly limited, and examples thereof include conditions such as a temperature rise rate during preheating: 1.0 to 3.0° C./sec, a preheat temperature: 150 to 180° C./60 to 100 sec, a temperature rise rate during solder melting: 1.0 to 2.0° C./sec, a melting temperature: 219° C. or higher and 30 seconds or more, and a reflow peak temperature: 230 to 250° C.

Next, the method of producing a solder material of the present embodiment will be described.

In the production method of the present embodiment, a flux containing a solvent, a rosin-based resin, and an activator is mixed with massive cellulose in which fibrous cellulose having a length of 1 μm or more and less than 1 mm and fibrous cellulose having a length of 1 nm or more and less than 1 μm are mixed to obtain a mixture, and the mixture is mixed with a solder alloy to produce a solder material.

In the production method of the present embodiment, a flux obtained by mixing the respective components is mixed with fibrous cellulose such as a powdery, a liquid obtained by impregnating the powder with a liquid such as water, or a liquid obtained by dispersing the powder in a liquid.

Although the fibrous cellulose can also be used at any state as described above, impregnating the fibrous cellulose with a liquid or dispersing the fibrous cellulose in a liquid makes it easy to allow the fibrous cellulose to uniformly exist in the solder material, and makes it easy to obtain a solder material capable of further suppressing scattering.

Examples of the liquid include pure water, water such as ion-exchanged water, and an organic solvent.

In the case of impregnating fibrous cellulose with a liquid, for example, 100% by mass or more and 10,000% by mass or less of the liquid with respect to the fibrous cellulose is stirred at a temperature of 10° C. or higher and 100° C. or lower for 5 minutes or more and 1440 minutes or less.

In the case of dispersing the fibrous cellulose in a liquid, for example, 100% by mass or more and 10,000% by mass or less of the liquid with respect to the fibrous cellulose is stirred at a temperature of 10° C. or higher and 100° C. or lower for 5 minutes or more and 1440 minutes or less.

As the flux, each flux as described above can be used.

Examples of a method of obtaining a mixture of the flux and the fibrous cellulose include stirring at a temperature of 10° C. or higher and 100° C. or lower for 1 minute or more and 120 minutes or less.

A ratio of the flux and the fibrous cellulose may be adjusted so that the massive cellulose is contained in the solder material at the ratio as described above.

In addition, the mixture and a solder alloy are mixed to obtain a solder material. Examples of the mixing conditions in this case include stirring at a temperature of 10° C. or higher and 100° C. or lower for 1 minute or more and 120 minutes or less.

A proportion of the flux, the fibrous cellulose, and the solder alloy in the solder material of the present embodiment is not particularly limited, and can be adjusted to, for example, the blending of each component to be the solder material of the present embodiment as described above.

In the production method of the present embodiment, examples of the method of mixing the components include mixing using a known mixing and stirring device or the like.

The solder material of the present embodiment and the solder material obtained by the production method of the present embodiment are suitable for electrical connection of electronic components, particularly all electronic components such as in-vehicle devices, outdoor displays, and mobile phones.

In particular, these solder materials can sufficiently suppress scattering of flux, solder balls, and the like even when heated in reflow or the like.

For example, in a vacuum reflow, gas is generated in a short time, and therefore, scattering is likely to occur; however, these solder materials can suppress scattering even by heating under a condition where scattering is likely to occur as in the vacuum reflow.

The solder composition of the present embodiment can sufficiently suppress scattering, and at the same time, can suppress a decrease in solder meltability.

When a component that is not dissolved in a liquid, such as cellulose, is blended in the solder material, there is a possibility that the solder meltability is affected; however, the solder material of the present embodiment does not decrease the solder meltability during reflow heating.

Although the solder material and the method of producing the solder material according to the present embodiment are as described above, it should be considered that the embodiment disclosed herein is an example in all respects and is not restrictive. The scope of the present invention is indicated not by the above description but by the claims, and it is intended that meanings equivalent to the claims and all modifications within the scope are included.

### EXAMPLES

Next, Examples of the present invention will be described together with Comparative Examples. The present invention is not to be construed as being limited to the following Examples.

### Preparation of Solder Material

Solder materials used in Examples and Comparative Examples were prepared with the materials and formulations shown in Table 1.

The materials used are as follows.

Each flux contains a solvent: diethylene glycol monohexyl ether and an activator: a carboxylic acid compound of a dibasic acid.

Each CMF is an aqueous dispersion of massive cellulose, the content in parentheses is a cellulose content, and an effective content of CMF in the table is the cellulose content (% by weight) in each CMF.

Flux 1: M406-3V (rosin-based, manufactured by KOKI Company Ltd.)

Flux 2: M650-3 (rosin-based, manufactured by KOKI Company Ltd.)

CMF1: Microcellulose 1, trade name “Exilva P01-V”, microfibrillated cellulose, manufactured by Borregaard AS, cellulose fiber content: 10%

CMF2: Microcellulose 2, trade name “Exilva F01-V”, microfibrillated cellulose, manufactured by Borregaard AS, cellulose fiber content: 10%

Solder alloy powder 96.5 Sn-3.0 Ag-0.5 Cu solder alloy, particle size 20 to 38 μm

The preparation method is as follows.

First, the flux and CMF were put in an appropriate container and mixed at 25° C. for 5 minutes.

The solder alloy powder and the mixture were mixed to prepare each paste-like solder material (solder paste).

The components were blended so as to have the proportions shown in Tables 1 and 2.

The unit of the numerical value regarding the component in the table is % by mass except for the effective cellulose equivalent. The effective cellulose equivalent indicates the content as cellulose in the flux in ppm.

A method of calculating the effective cellulose equivalent (ppm) is as follows.

Effective cellulose equivalent (ppm)=content (wt %) in cellulose material×added amount (wt %) in solder material×100

The measurement method is as follows.

First, cellulose is subjected to reparatory extraction using a more appropriate solvent species in the solder material. The resulting cellulose suspension is dried and weighed. Qualitative analysis of cellulose is performed using a Fourier transform infrared spectrophotometer (FT-IR) (Frontier, manufactured by PerkinElmer Co., Ltd.).

A method of measuring the effective cellulose equivalent (ppm) is as follows.

Effective cellulose equivalent (ppm)=weight (g) of separated and extracted cellulose/weight (g) of solder material used in extraction operation×1 million.

### Test Piece

The following test pieces were prepared for evaluation of scattering and evaluation of solder meltability.

### For Evaluation of Scattering

Two copper plates having a size of 30 mm square and a thickness of 0.3 mm were prepared as one set. Each solder material was applied by printing to the surface of one of the copper plates using a metal mask having a diameter of 6.5 mm and a thickness of 0.2 mm. Another copper plate was disposed above the copper plate coated with the solder material with a spacer so as to be spaced 2 mm apart.

Three sets of such a set of copper plates were prepared for each solder material, and heated under the following heating conditions.

After the heating, the number of scattering objects adhering to the surface of the copper plate disposed on an upper portion was visually counted. A case where an average of the count numbers of the three sets was 15 or less was regarded as pass (OK), and a case where the average was more than 15 was regarded as fail (NG).

### Heating Conditions

Reflow oven: NIS-20-80C (manufactured by EIGHTECH TECTRON Co., Ltd.)

Temperature rise rate: 1.0° C./sec

Heating condition: 30 seconds at 220° C. or higher

Peak temperature: 240° C.

The results are shown in Tables 1 and 2.

### For Evaluation of Meltability

A copper clad laminate having a size of 100 mm×100 mm and a thickness of 1.6 mm was provided, and each of the solder materials of Examples and Comparative Examples was printed in a size of 0.3 mm×0.3 mm square using a metal mask having a printing thickness of 120 μm. After printing, a chip resistance (Sn plating treatment) of 0603 size (0.6 mm×0.3 mm) was mounted at a predetermined position.

Thereafter, heating was performed at an oxygen concentration of 5,000 ppm under the same temperature conditions as in the scattering test and a nitrogen atmosphere.

After heating, each substrate was observed with an optical microscope, and a case where gloss was uniformly observed in a fillet portion is regarded as pass (OK).

The results are shown in Tables 1 and 2.

TABLE 1

| | | | Example 1 | Example 2 | Example 3 | Example 4 | Example 5 | Example 6 | Example 7 | Example 8 |
|---|---|---|---|---|---|---|---|---|---|---|
| Blending | Flux | Flux 1 | 11.5 | | 11.5 | 11.5 | 11.5 | 11.5 | 11.5 | 11.5 |
| amount of | | Flux 2 | | 12.0 | | | | | | |
| solder | | CMF1 | 0.3 | 0.3 | 0.05 | 0.1 | 0.5 | 1.0 | 1.5 | 2.0 |
| composition | | CMF2 | | | | | | | | |
| (mass %) | Solder alloy powder | | 88.2 | 87.7 | 88.5 | 88.4 | 88.0 | 87.5 | 87.0 | 86.5 |
| | Solder material total | | 100 | 100 | 100 | 100 | 100 | 100 | 100 | 100 |
| CMF content | Effective content of CMF (%) | | 0.030 | 0.030 | 0.005 | 0.010 | 0.050 | 0.100 | 0.150 | 0.200 |
| | Effective amount in | | 300 | 300 | 50 | 100 | 500 | 1000 | 1500 | 2000 |
| | solder material (ppm) | | | | | | | | | |
| | Scattering | Number | 5 | 2 | 18 | 11 | 0 | 0 | 0 | 0 |
| | | | 3 | 1 | 9 | 14 | 0 | 0 | 0 | 0 |
| | | | 0 | 2 | 16 | 13 | 0 | 0 | 0 | 0 |
| | | Number | 2.7 | 1.7 | 14.3 | 12.7 | 0.0 | 0.0 | 0.0 | 0.0 |
| | | (n3 average) | | | | | | | | |
| | | Determination | OK | OK | OK | OK | OK | OK | OK | OK |
| | Meltability | Determination | OK | OK | OK | OK | OK | OK | OK | OK |

TABLE 2

| | | | | | | | | Comparative | Comparative |
|---|---|---|---|---|---|---|---|---|---|
| | | | Example 9 | Example 10 | Example 11 | Example 12 | Example 13 | Example 1 | Example 2 |
| Blending | Flux | Flux 1 | 11.5 | 11.5 | 11.5 | 11.5 | 11.5 | 11.5 | |
| amount of | | Flux 2 | | | | | | | 12.0 |
| solder | | CMF1 | | | | | | | |
| composition | | CMF2 | 0.3 | 5.0 | 10.0 | 15.0 | 20.0 | | |
| (mass %) | Solder alloy powder | | 87.5 | 83.5 | 78.5 | 73.5 | 87.5 | 88.5 | 88.0 |
| | Solder composition total | | 100 | 100 | 100 | 100 | 100 | 100 | 100 |
| CMF content | Effective amount content | | 0.030 | 0.500 | 1.000 | 1.500 | 2.000 | 0.000 | 0.000 |
| | of CMF (%) | | | | | | | | |
| | Effective amount in solder | | 300 | 5000 | 10000 | 15000 | 20000 | 0 | 0 |
| | material (ppm) | | | | | | | | |
| | Scattering | Number | 0 | 0 | 0 | 0 | 0 | 80 | 23 |
| | | | 0 | 0 | 0 | 0 | 0 | 44 | 56 |
| | | | 0 | 0 | 0 | 0 | 0 | 40 | 53 |
| | | Number | 0 | 0 | 0 | 0 | 0 | 55 | 44 |
| | | (n3 average) | | | | | | | |
| | | Determination | OK | OK | OK | OK | OK | NG | NG |
| | Meltability | Determination | OK | OK | OK | OK | OK | OK | OK |

As shown in Tables 1 and 2, scattering was suppressed in Examples as compared with Comparative Examples. The solder meltability was also all evaluated as pass.

From this result, it can be said that in Examples, scattering during heating could be suppressed without impairing the solder meltability.

Observation of Cellulose with Electron Microscope

The following celluloses were provided as samples.

Cellulose powder 1: NP fiber (manufactured by Nippon Paper Industries Co., Ltd.)

Cell lose powder 2: KC Flock (manufactured by Nippon Paper Industries Co., Ltd.)

Cellulose nanofiber 1: Cellenpia TC-01 (manufactured by Nippon Paper Industries Co., Ltd.)

Cellulose nanofiber 2: Rheocrysta (manufactured by DKS Co. Ltd.)

Cellulose microfiber 1: Exilva (2 wt %) (manufactured by Borregaard AS)

Cell lose microfiber 2: Exilva (10 wt %) (manufactured by Borregaard AS)

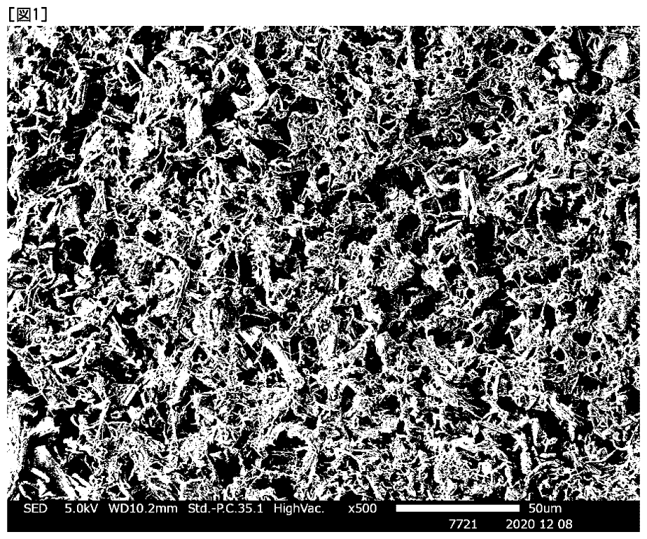

For each cellulose sample, a 0.1% by weight suspension was prepared with pure water, applied onto a copper plate, and then dried in an oven at 80° C. for 16 hours to prepare a test piece. The obtained test piece was subjected to platinum vapor deposition and then observed with an observation apparatus, and an electron micrograph was taken. The photograph is shown in FIGS. 1 to 14.

Observation apparatus: JSM-IT 300 LV (manufactured by JEOL Ltd.)

Observation magnification: 500 times, 2,000 times, 20,000 times

The observation magnification of each sample is as follows.

Observation result of cellulose powder 1 at 500 magnification (FIG. 1)

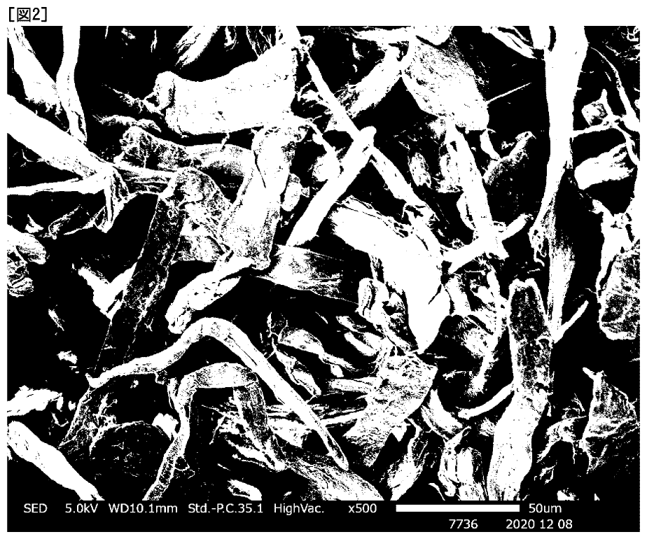

Observation result of cellulose powder 2 at 500 magnification (FIG. 2)

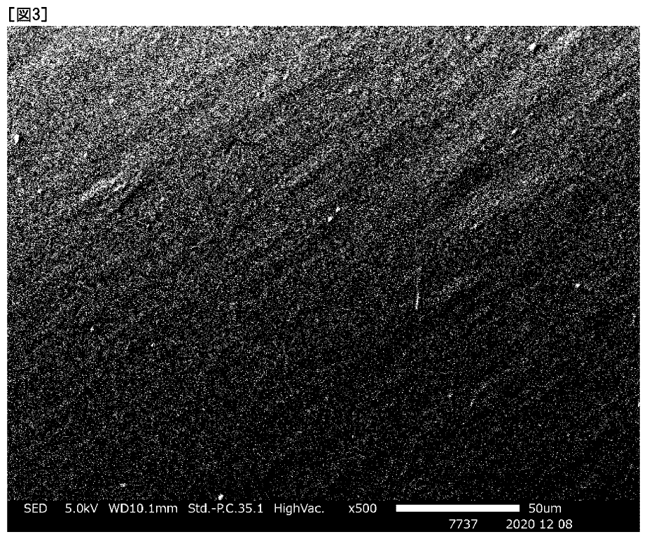

Observation result of cellulose nanofiber 1 at 500 magnification (FIG. 3)

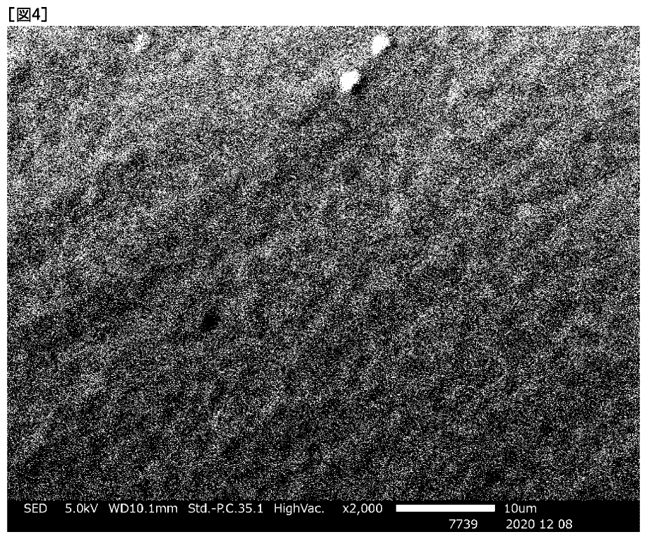

Observation result of cellulose nanofiber 1 at 2,000 magnification (FIG. 4)

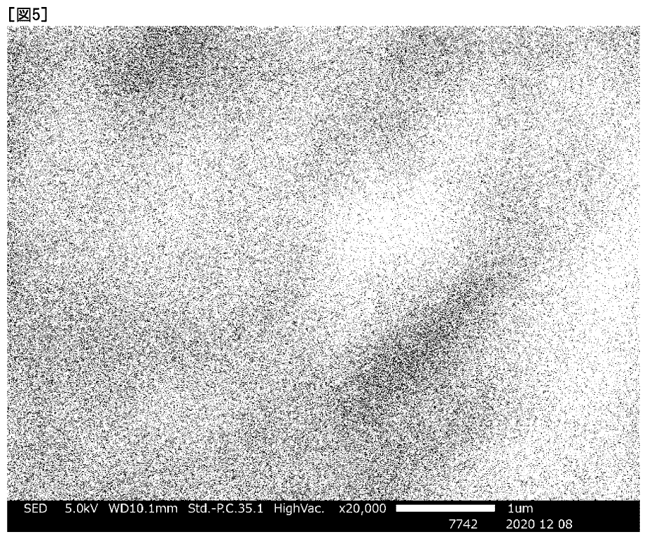

Observation result of cellulose nanofiber 1 at 20,000 magnification (FIG. 5)

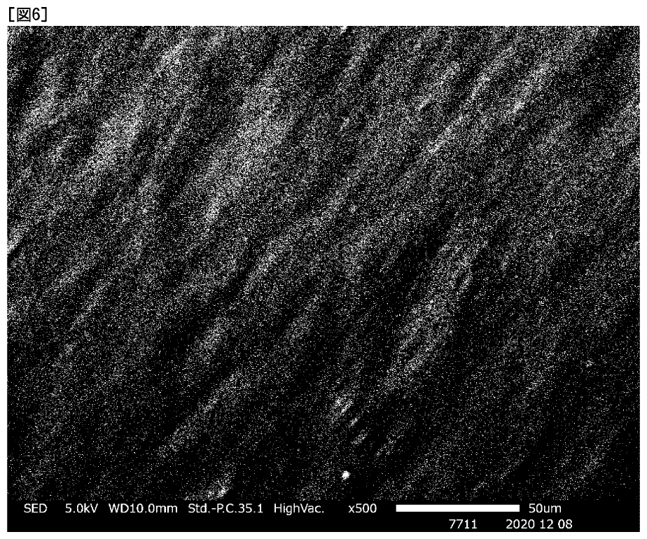

Observation result of cellulose nanofiber 2 at 500 magnification (FIG. 6)

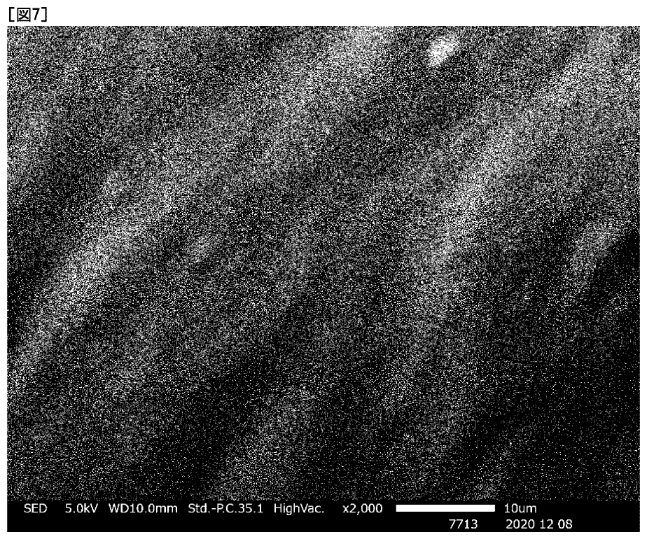

Observation result of cellulose nanofiber 2 at 2,000 magnification (FIG. 7)

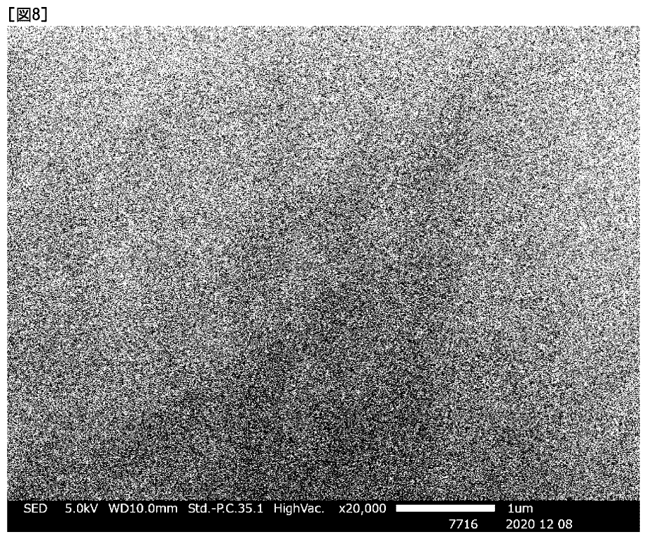

Observation result of cellulose nanofiber 2 at 20,000 magnification (FIG. 8)

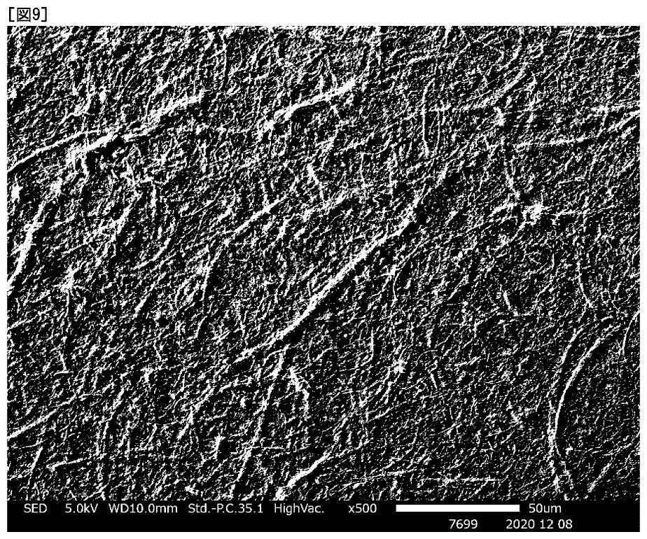

Observation result of cellulose microfiber 1 at 500 magnification (FIG. 9)

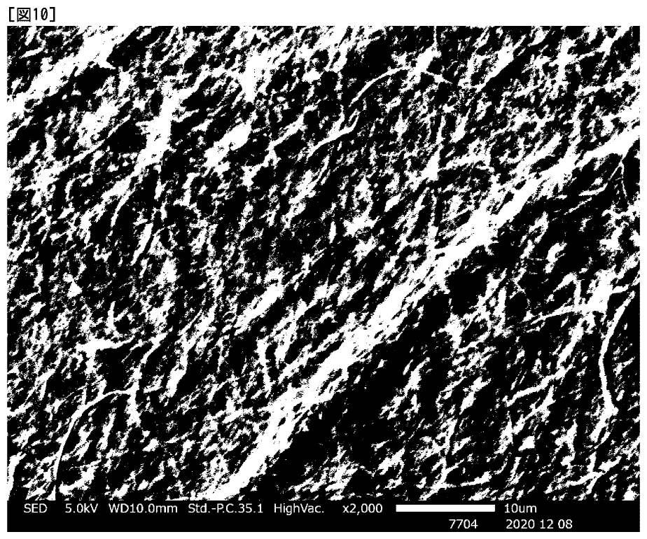

Observation result of cellulose microfiber 1 at 2,000 magnification (FIG. 10)

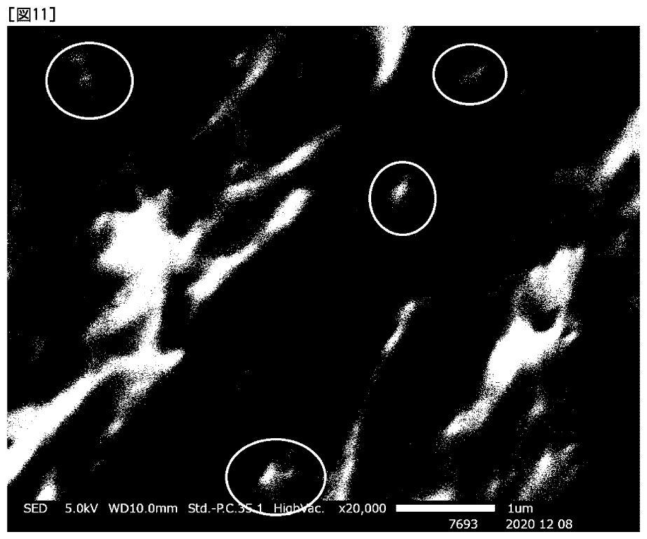

Observation result of cellulose microfiber 1 at 20,000 magnification (FIG. 11)

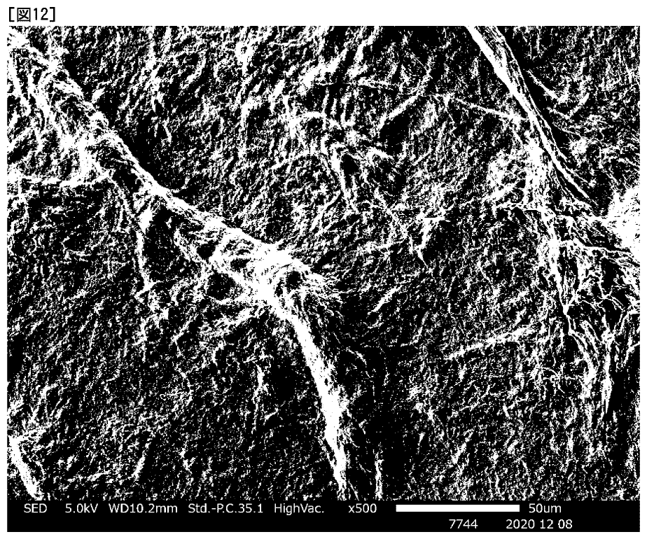

Observation result of cellulose microfiber 2 at 500 magnification (FIG. 12)

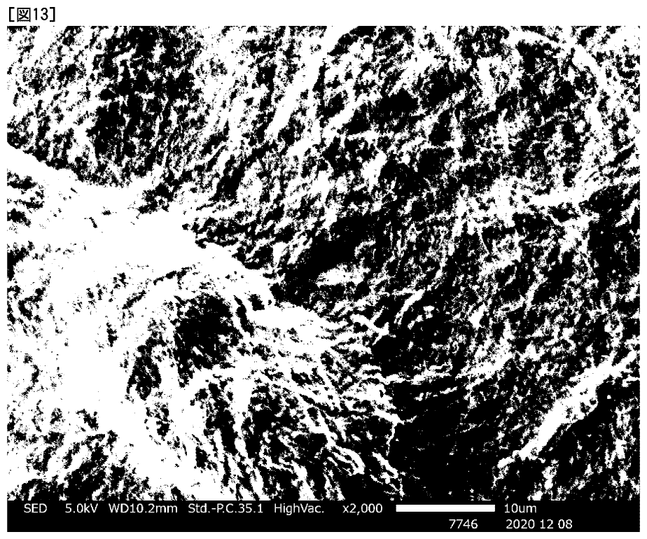

Observation result of cellulose microfiber 2 at 2,000 magnification (FIG. 13)

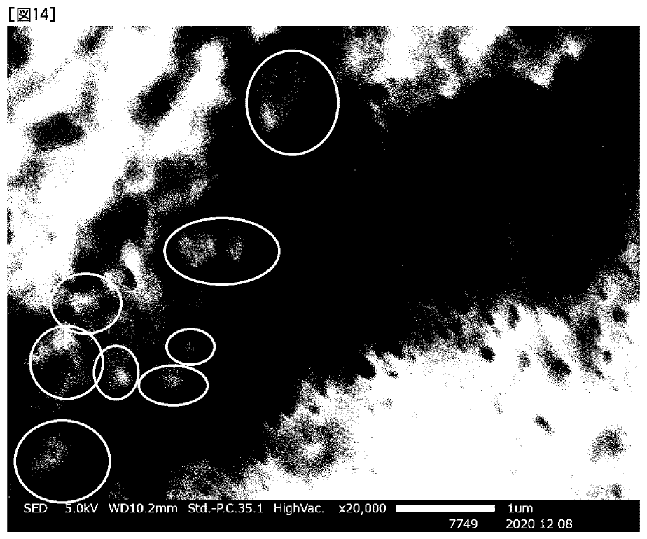

Observation result of cellulose microfiber 2 at 20,000 magnification (FIG. 14)

In the cellulose powder shown in FIGS. 1 and 2, while a granular structure was observed, no fiber piece was observed.

In the nanofibers shown in FIGS. 3 to 8, particles and fibers were not observed at the observation magnification. It is presumed that individual particles or fibers cannot be observed at this magnification because of very fine particles or aggregates of fibers.

In the cellulose microfibers shown in FIGS. 9 to 14, a fibrous structure was observed at the observation magnification.

In FIGS. 9 and 12, a state in which large fiber pieces having a scale of several tens of μm observed as a linear body and very finer fiber pieces are complicatedly intertwined is observed. In FIGS. 10 and 13, it was observed that there were fiber pieces having a size of about several μm and finer fiber pieces, and in FIGS. 11 and 14 at a higher magnification, it was observed that the smallest fiber piece had a size of 1 μm or less (portion surrounded by a circle in the drawing). That is, it was observed that massive fibers in which fibers having different sizes were mixed existed.

1. A solder material comprising massive cellulose in which fibrous cellulose having a length of 1 μm or more and less than 1 mm and fibrous cellulose having a length of 1 nm or more and less than 1 μm are mixed.

2. The solder material according to claim 1, wherein 50 ppm or more and 20,000 ppm or less of the massive cellulose is contained.

3. The solder material according to claim 1, further comprising a flux containing a solvent, a rosin-based resin, and an activator.

4. A method of producing a solder material, the method comprising mixing a flux containing a solvent, a rosin-based resin, and an activator with massive cellulose in which fibrous cellulose having a length of 1 μm or more and less than 1 mm and fibrous cellulose having a length of 1 nm or more and less than 1 μm are mixed to obtain a mixture, and mixing the mixture with a solder alloy to produce a solder material.

5. The solder material according to claim 2, further comprising a flux containing a solvent, a rosin-based resin, and an activator.
